(19) United States
(12) Patent Application Publication
(10) Pub. No.: US 2012/0160649 A1
(43) Pub. Date: Jun. 28, 2012

(54) DUST-FREE BUTTON ASSEMBLY

(76) Inventors: Shao-Yu Hwang, Taipei City (TW); Stephen Tsai, Taipei County (TW)

(21) Appl. No.: 13/153,084

(22) Filed: Jun. 3, 2011

(30) Foreign Application Priority Data
Dec. 24, 2010 (TW) 99145947

(51) Int. Cl. H01H 13/14

(52) U.S. Cl. 200/345

(57) ABSTRACT

A dust-free button assembly is disposed on a substrate carrying a switch to be triggered to generate a signal. The dust-free button assembly includes a flexible member disposed on the substrate and a pressed body disposed above the switch. The pressed body includes a button cap and a post. The button cap includes an upper surface and a recessed lower surface. One end of the post is connected to the lower surface while the other end is connected to the flexible member. An air tunnel runs through the post, and the post includes an outlet communicating the air tunnel. An air-contained-space is defined between the post, the flexible member, and the substrate; and the air tunnel communicates the air-contained-space. When the flexible member is deformed by the post, the air in the air-contained-space is forced to be exhausted through the air tunnel and the outlet to remove dust.

### CROSS-REFERENCES TO RELATED APPLICATIONS

This non-provisional application claims priority under 35 U.S.C. §119(a) on Patent Application No. 99145947 filed in Taiwan, R.O.C. on 2010 Dec. 24, the entire contents of which are hereby incorporated by reference.

### BACKGROUND OF THE INVENTION

1. Technical Field

The present invention relates to a button structure, and more particularly to a dust-free button assembly, that can perform self-cleaning function.

2. Related Art

A common electronic device on the market, such as a mobile phone, a laptop computer, or a desktop computer, has physical keyboards to serve as an operation interface for the user to operate the electronic device, though a touch screen or a touch pad usually replaces a physical keyboard in the current electronic device. However, since the physical keyboard provides users with reassuring tactile feedback, it is still a popular peripheral in an electronic device.

A common keyboard includes a plurality of keys, and adjacent keys are separated by a suitable gap, such that when pressing the keys, it will not interfere with each other. Because of this structural arrangement, after being used for a period of time, dust particles in the air usually fall on the keys and between the gaps, and the keyboard becomes dirty. Sometimes, dust particles can affect the operation of the keyboard. It is therefore necessary to clean the keyboard frequently, to keep the keyboard clean in appearance and in a normal operation.

To clean the keyboard, a cloth is always used to clean the surfaces of the keys of the keyboard, and a sharp elongated object wrapped with a cleaning cloth is then inserted into the gaps between the keys to wipe back and forth between the gaps in order to remove the dirt and dust. However, such a cleaning method has the following disadvantages. For example, the cleaning cloth is a sheet-like object and cannot be held and operated easily during the cleaning operation. The surface of the key is not flat, and the surface and the four sides of the key have a range of different angles, so that the cleaning cloth cannot clean all surfaces of the key, and the cleaning effect is suboptimal. The gaps between the keys has to be cleaned with an elongated object, which is very inconvenient to use, and furthermore if the selected elongated object is too thick it difficult to inserted into the gaps between the keys, and if the elongated object is too sharp, it will easily damage the keyboard.

As a result, keeping the keys of the keyboard clean to improve the convenience of use is a problem to be solved by the inventors of the present invention and persons skilled in the art.

### SUMMARY

The button structure in the prior art has to be cleaned with a cleaning cloth or an elongated object. The cleaning effect cannot be achieved in some places in the button structure, and if an elongated object is used, structural damage to the button structure usually occurs.

In order to solve these problems, the present invention is directed to a dust-free button assembly, which has a simple structure, self-cleaning performance, and does not cause damage to the keyboard by cleaning with an elongated object.

The dust-free button assembly of the present invention is disposed on a substrate. The substrate carries a switch, and the switch is for being triggered by the dust-free button assembly to generate a triggering signal. The dust-free button assembly includes a flexible member and a pressed body.

The flexible member is disposed on the substrate. The pressed body is disposed above the switch, and includes a button cap and a post. The button cap includes an upper surface and a recessed lower surface. One end of the post is connected to the lower surface while the other end is connected to the flexible member. An air tunnel is formed in the post, and the post has an outlet communicated with the air tunnel. An air-contained-space is defined between the post, the flexible member, and the substrate, and the air tunnel of the post is connected to the air-contained-space. The flexible member is for being pressed by the post to compress air in the air-contained-space, such that the air is pumped out through the air tunnel and the outlet.

In the present invention, through the arrangement of the air-contained-space, the air is continuously blown during the use of the dust-free button assembly, so as to perform self-cleaning of the dust-free button assembly, thus reducing the frequent cleaning with external force, so as to avoid the problem faced by the conventional key structure.

The detailed features and advantages of the present invention are described below in detail through the following embodiments, and the content of the detailed description is sufficient for those skilled in the art to understand the technical content of the present invention and to implement the present invention accordingly. On the basis of the content of the specification, the claims, and the drawings, those skilled in the art can easily understand the relevant objectives and advantages of the present invention.

### BRIEF DESCRIPTION OF THE DRAWINGS

The present invention will become more fully understood from the detailed description given herein below for illustration only and thus not limitative of the present invention, wherein:

FIGS. 1A, 1B, and 1C are schematic cross-sectional views according to a first embodiment of the present invention;

FIG. 2 is a schematic cross-sectional view according to a second embodiment of the present invention;

FIGS. 3A and 3B are schematic cross-sectional views according to a third embodiment of the present invention;

FIGS. 4A and 4B are schematic cross-sectional views according to a fourth embodiment of the present invention; and

FIGS. 5A and 5B are schematic cross-sectional views according to a fifth embodiment of the present invention.

### DETAILED DESCRIPTION

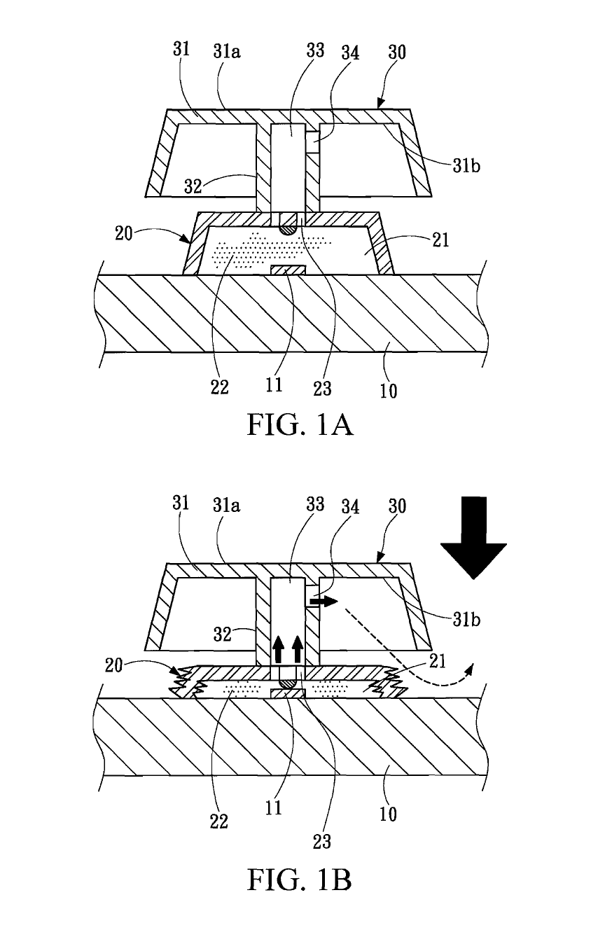

FIG. 1A illustrates a dust-free button assembly according to a first embodiment of the present invention. The dust-free button assembly is disposed on a substrate 10, where the substrate 10 is a printed circuit board (PCB) or an ordinary board arranged with electrical wires for providing power and signal transmission. The substrate 10 carries a switch 11 for generating a triggering signal. The dust-free button assembly includes a flexible member 20 and a pressed body 30.

As illustrated in FIG. 1A, the flexible member 20 is disposed on the substrate 10 to define an air-contained-space 21 on the substrate 10. The air-contained-space 21 is filled with air 22. Accordingly, the flexible member 20 has an air vent 23, such that the air 22 enters the air-contained-space 21, and is pumped out of the air-contained-space 21 through the air vent 23. Additionally, the flexible member 20 is preferably made of rubber, silicon or plastic with flexibility materials.

As illustrated in FIG. 1A, the pressed body 30 is disposed above the switch 11, for being pressed to triggered the switch 11. The pressed body 30 includes a button cap 31 and a post 32. The button cap 31 includes an upper surface 31a and a recessed lower surface 31b. One end of the post 32 is connected to the lower surface 31b of the button cap 31, and an air tunnel 33 is formed in the post 32. Secondly, the other end of the post 32 is connected to the flexible member 20, such that the air tunnel 33 is communicated with the air vent 23 of the flexible member 20. Due to the connection between the flexible member 20 and the post 32, the air 22 in the air-contained-space 21 when is compressed the air 22 then circulated to the air tunnel 33 and through the air vent 23.

Referring to FIG. 1A again, the post 32 has an outlet 34 communicating the air tunnel 33, such that the air 22 in the air-contained-space 21 is pumped out of the air-contained-space 21 through the air vent 23, and then passes through the air tunnel 33 and is exhausted out through the outlet 34.

Referring to FIG. 1B, when the pressed body 30 is pressed, for example, a user presses the upper surface 31a of the button cap 31 with his/her hand, the post 32 moves downwards towards the substrate 10 and compresses the flexible member 20, and then the post 32 triggers the switch 11 directly or indirectly through the flexible member 20. When the flexible member 20 is pressed, the air 22 in the air-contained-space 21 is compressed to enter the air tunnel 33 through the air vent 23. At this time, the air 22 in the flexible member 20 exits the flexible member 20 through the outlet 34, and then the air 22 is blown towards the substrate 10, so as to carry away dirt such as dust on the surface of the substrate 10.

Referring to FIG. 1C, when the pressed body 30 is released and is not pressed any more, the flexible member 20 returns to the original shape by means of its resilience, and drives the post 32 to make the pressed body 30 bound upwards. The air 22 outside is sucked by the low pressure generated the flexible member 20, and the air 22 is filled in the air-contained-space 21 of the flexible member 20 through the outlet 34.

Due to the arrangement of the air vent 23, when the pressed body 30 is pressed to compress the flexible member 20, the air 22 of the air-contained-space 21 passes through the air vent 23 and the air tunnel 33 then is exhausted out through the outlet 34. The air 22 exhausted blows the dirt on the bottom area of the dust-free button assembly (on the substrate 10); so as to effectively clean the dust-free button assembly. The dust-free button assembly can perform a self-cleaning operation at any time during the use of the dust-free button assembly, and thus the frequent cleaning of the dust-free button assembly performed by the user is reduced.

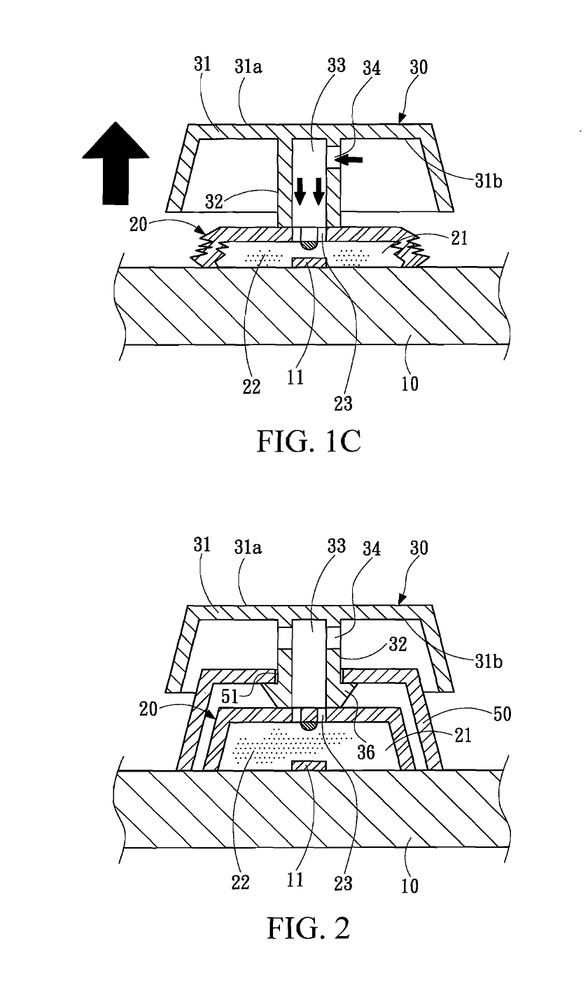

FIG. 2 illustrates a dust-free button assembly according to a second embodiment of the present invention. The dust-free button assembly includes a flexible member 20, a pressed body 30, and a base 50. The flexible member 20 and the pressed body 30 in the second embodiment are the same as those in the first embodiment.

As illustrated in FIG. 2, the base 50 is disposed on the substrate 10 to define an accommodation space for accommodating the flexible member 20. The base 50 has an opening 51 communicating the accommodation space. A post 32 runs through the opening 51 and is connected to the flexible member 20, and a button cap 31 and the flexible member 20 are separated by the base 50. The opening 51 is used for limiting the movement direction of the post 32, such that the pressed body 30 moves towards or away from the substrate 10 in a single direction. In addition, the post 32 has a latch 36 disposed at one end of the post 32 corresponding to the flexible member 20. The latch 36 is for being stopped by the inner surface of the base 50, such that the post 32 will not depart from the base 50 through the opening 51 when the pressed body 30 moves in a single direction.

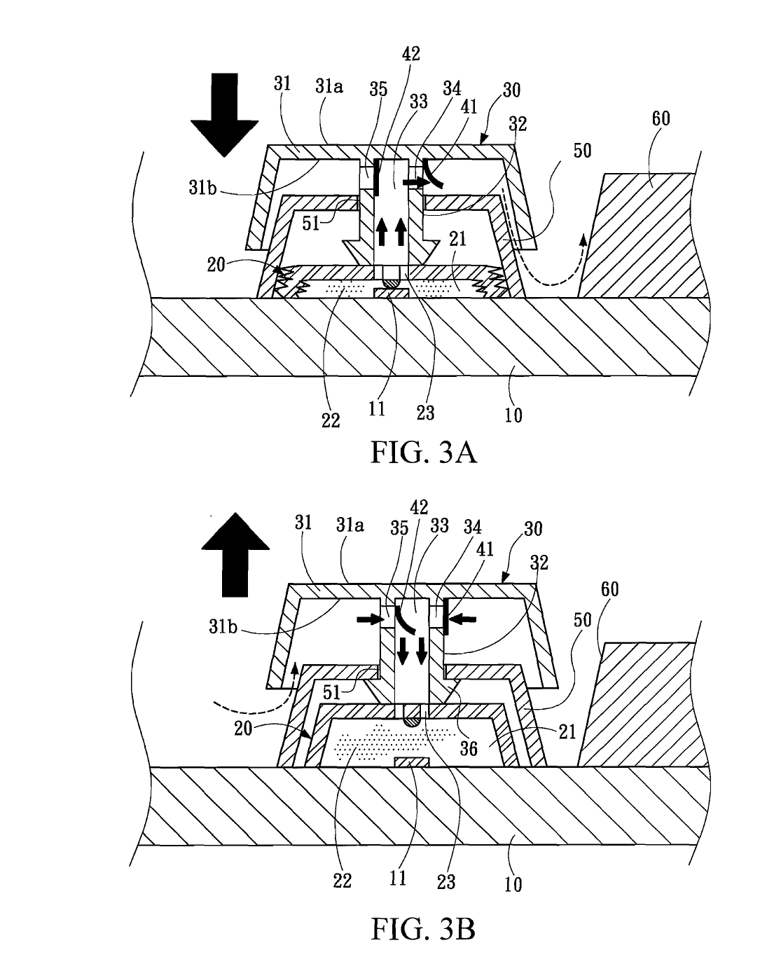

FIGS. 3A and 3B illustrate a dust-free button assembly according to a third embodiment of the present invention. The dust-free button includes a flexible member 20, a pressed body 30, a base 50, and a slope 60. The flexible member 20 and the pressed body 30 in the third embodiment are the same as those in the first and second embodiments. The slope 60 of the third embodiment is disposed on the substrate 10 and close to the pressed body 30, and the slope 60 tilts in a direction away from the pressed body 30.

In addition, the post 32 has an outlet 34 and an inlet 35 communicating the air tunnel 33 of the post 32, and the dust-free button assembly further includes an outlet valve 41 and an inlet valve 42. The outlet valve 41 seals the outlet 34 in one-way manner, such that the air 22 exits the air tunnel 33 through the outlet 34 in one-way manner. The inlet valve 42 seals the inlet 35 in one-way manner, such that the air 22 can only enter the air tunnel 33 through the inlet 35 from the outside in one-way manner.

Specific embodiments of the outlet valve 41 and the inlet valve 42 are thin films 0. The thin film serving as the outlet valve 41 is partially connected to an outer surface of the post 32, so as to cover the outlet 34; and the thin film serving as the inlet valve 42 is partially connected to an inner wall of the air tunnel 33, so as to cover the inlet 35.

As illustrated in FIG. 3A, when the pressed body 30 is pressed, for example, a user presses the upper surface 31a of the button cap 31 with a hand, the post 32 moves towards the substrate 10 and compresses the flexible member 20. Then the post 32 triggers the switch 11 directly or indirectly through the flexible member 20. When the flexible member 20 is compressed, the air 22 in the air-contained-space 21 is compressed to enter the air tunnel 33 through the air vent 23.

At this time, pushed by the air 22 in the air tunnel 33, the inlet valve 42 seals the inlet 35, and the outlet valve 41 opens the outlet 34, such that the air 22 in the flexible member 20 exits the flexible member 20 through the outlet 34 and is blown towards the substrate 10. The position of the outlet 34 is disposed corresponding to the slope 60, such that the air 22 blown towards the substrate 10 is further guided by the slope 60 and blows away the dirt such as dust on the surface of the substrate 10.

As shown in FIG. 3B, when the pressed body 30 is released and is not pressed any more, the flexible member 20 returns to the original shape by means of its resilience, and drives the post 32 to make the pressed body 30 bound upwards. Due to the arrangement of the latch 36, when the pressed body 30 bounds upwards, as the latch 36 is stopped by the base 50, the pressed body 30 will not depart from the flexible member 20 and returns to the original position. At the same time, the air 22 outside is sucked by low pressure generated by the flexible member 20, and the air 22 pushes the outlet valve 41 and the inlet valve 42. The inlet valve 42 opens the inlet 35, and the outlet valve 41 closes the outlet 34, such that the air 22 is filled in the air-contained-space 21 of the flexible member 20 through the inlet 35. The outlet 34 does not suck the air 22, thus avoiding the suction of the dirt blown away from the slope 60 through the outlet 34.

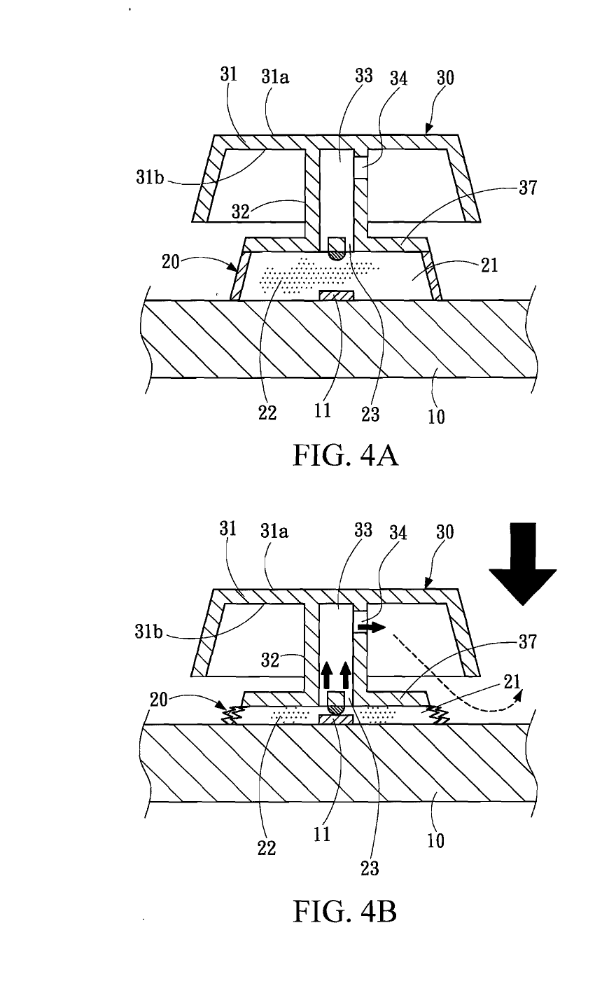

FIGS. 4A and 4B illustrate a dust-free button assembly according to a fourth embodiment, which includes a flexible member 20 and a pressed body 30.

As illustrated in FIGS. 4A and 4B, the flexible member 20 is an annular wall, and is disposed on the substrate 10. The pressed body 30 includes a button cap 31, a post 32, and a flange 37. The button cap 31 includes an upper surface 31a and a recessed lower surface 31b. One end of the post 32 is connected to the lower surface 31b of the button cap 31, and an air tunnel 33 is formed in the post 32. The flange 37 protrudes from a peripheral surface of the post 32, and the flange 37 tightly compresses the air 22 in the air-contained-space 21 of the flexible member 20. Thus, the air 22 in the air-contained-space 21 compressed by the flange 37 of the post 32 flows towards the air tunnel 33 through the air vent 23.

In addition, the flexible member 20, the button cap 31, the post 32, and the flange 37 can be formed monolithically, thus simplifying the fabrication process of the dust-free button assembly.

Please refer to FIGS. 4A and 4B, the post 32 has an outlet 34 communicating the air tunnel 33, such that the air 22 in the air-contained-space 21 is exhausted out of the air-contained-space 21 through the air vent 23. Then the air 22 passes through the air tunnel 33 and is exited out through the outlet 34, or enters the air tunnel 33 through the outlet 34 and is filled in the air-contained-space 21.

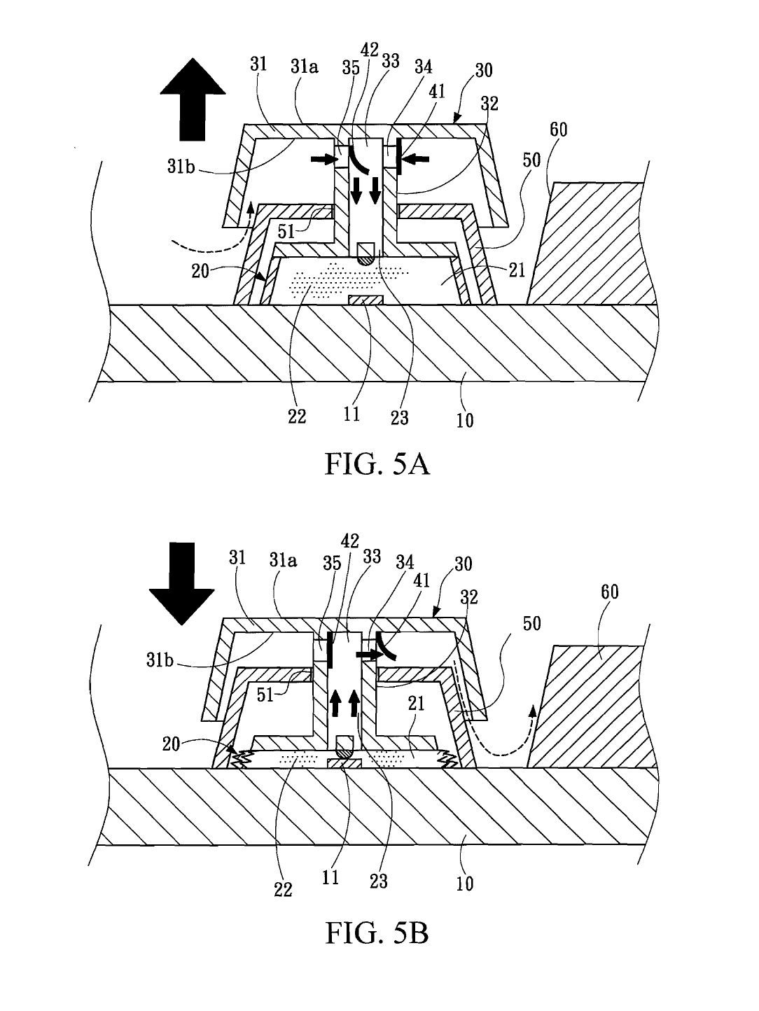

FIGS. 5A and 5B illustrate a dust-free button assembly according to a fifth embodiment of the present invention, the dust-free button assembly includes a flexible member 20, a pressed body 30, a base 50, and a slope 60. The flexible member 20 and the pressed body 30 in the fifth embodiment is the same as those in the fourth embodiment.

As illustrated in FIGS. 5A and 5B, the base 50 is disposed on the substrate 10 to define an accommodation space on the substrate 10 for accommodating the flexible member 20. The base 50 has an opening 51 communicating the accommodation space. The post 32 runs through the opening 51 and is connected to the flexible member 20, and the button cap 31 and the flexible member 20 are separated by the base 50. The opening 51 is used for limiting the movement direction of the post 32, such that the pressed body 30 moves towards or away from the substrate 10 in a single direction.

In addition, the post 32 has an outlet 34 and an inlet 35 communicating the air tunnel 33 of the post 32, and the dust-free button assembly further includes an outlet valve 41 and an inlet valve 42. The outlet valve 41 seals the outlet 34 in one-way manner, and the inlet valve 42 seals the inlet 35 in one-way manner.

The slope 60 is disposed on the substrate 10 and close to the pressed body 30, and the slope 60 tilts in a direction away from the pressed body 30. The position of the outlet 34 is disposed corresponding to the slope 60.

As shown in FIGS. 5A and 5B, when the pressed body 30 is pressed, the post 32 and the flange 37 move towards the substrate 10 and press the flexible member 20, such that the air 22 in the air-contained-space 21 is compressed to enter the air tunnel 33 through the air vent 23. At this time, the inlet valve 42 seals the inlet 35, and the outlet valve 41 opens the outlet 34, such that the air 22 in the air tunnel 33 exits the air tunnel 33 through the outlet 34 and is blown towards the substrate 10. The air 22 blown towards the substrate 10 is further guided by the slope 60, and then the air 22 blows away the dirt such as dust on the surface of the substrate 10.

As illustrated in FIGS. 5A and 5B, when the pressed body 30 is released and is not pressed any more, the flexible member 20 returns to the original shape by means of its resilience, and drives the post 32 and the flange 37 to make the pressed body 30 bound upwards. The air 22 outside is sucked by the low pressure generated by the flexible member 20 and the air 22 pushes the outlet valve 41 and the inlet valve 42. The inlet valve 42 opens the inlet 35, and the outlet valve 41 closes the outlet 34, such that the air 22 is filled in the air-contained-space 21 of the flexible member 20 through the inlet 35.

In this manner, when the user strikes the button assembly, the air 22 in the air-contained-space 21 is blown out continuously, so the air 22 around the substrate 10 or the button assembly is circulated continuously. Dirt such as dust or moisture will not be attached to the substrate 10 or the button assembly; such that the dust-free button assembly of the embodiments of the present invention effectively prevents itself from getting dirty, thus reducing the number of times of cleaning, and prolonging the service life of the keyboard.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A dust-free button assembly, disposed on a substrate, wherein the substrate carries a switch, and the switch is to be triggered by the dust-free button assembly to generate a triggering signal; the dust-free button assembly comprising:
a flexible member, disposed on the substrate, to define an air-contained-space on the substrate; and
a pressed body, disposed above the switch, and comprising:
a button cap, comprising an upper surface and a recessed lower surface; and
a post, comprising one end connected to the lower surface, and the other end connected to the flexible member; wherein an air tunnel runs through the post, and the post comprises an outlet communicating the air tunnel; wherein the air tunnel communicates the air-contained-space; the flexible member is for being pressed by the post to compress air in the air-contained-space to be exhausted out through the air tunnel and the outlet.

2. The dust-free button assembly as claimed in claim 1, wherein the flexible member comprises an air vent, and the air tunnel communicates the air-contained-space through the air vent.

3. The dust-free button assembly as claimed in claim 1, further comprising a base disposed on the substrate to define an accommodation space for accommodating the flexible member, wherein the base comprises an opening communicating the accommodation space, and the post runs through the opening and is connected to the flexible member.

4. The dust-free button assembly as claimed in claim 3, wherein the post further comprises a latch for being stopped by an inner surface of the base, such that the post remains operating within the base without departing from the base through the opening.

5. The dust-free button assembly as claimed in claim 1, wherein the flexible member is an annular wall disposed on the substrate; the pressed body further comprises a flange protruding from a peripheral surface of the post; and the flange tightly compresses the air-contained-space defined by the annular flexible member.

6. The dust-free button assembly as claimed in claim 1, wherein the flexible member, the button cap, the post, and the flange are formed monolithically.

7. The dust-free button assembly as claimed in claim 1, further comprising a slope, disposed on the substrate and close to the pressed body, and tilting in a direction away from the pressed body.

8. The dust-free button assembly as claimed in claim 1, wherein the post further comprises an inlet.

9. The dust-free button assembly as claimed in claim 8, further comprising:
an outlet valve, for sealing the outlet in one-way manner, such that air is allowed to exit the air tunnel of the post through the outlet in one-way manner; and
an inlet valve, for sealing the inlet in one-way manner, such that the air is allowed to enter the air tunnel of the post through the inlet in one-way manner.

10. The dust-free button assembly as claimed in claim 9, further comprising a slope disposed on the substrate and close to the pressed body, and tilting in a direction away from the pressed body, wherein a position of the outlet is disposed corresponding to the slope.
